(19) United States
(12) Patent Application Publication
(10) Pub. No.: US 2008/0067713 A1
(43) Pub. Date: Mar. 20, 2008

(54) METHOD OF PRODUCING AND BUSINESS MODEL FOR APPLYING A THIN LAMINATE SHEET OF A DECORATIVE MATERIAL

(76) Inventor: ROBERT BORDENER, Bloomfield Hiis, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/856,853

(22) Filed: Sep. 18, 2007

Related U.S. Application Data
(62) Division of application No. 11/011,634, filed on Dec. 14, 2004.

(51) Int. Cl. B29C 47/04; B29C 39/12

(52) U.S. Cl. 264/211.12; 264/245; 264/299

(57) ABSTRACT

A flexible and decorative laminate material constructed from an extruded sheet and including a thermoplastic resin base admixed with a volume of a decorative additive, such as compounded granulate. The laminate veneer sheet thus created exhibits at least one substantially transparent viewing surface, combined with an opaque interior and which is capable of being coiled about its least planar dimension to a diameter lesser than the dimension. Typically, the sheet is packaged and shipped to a remote location, prior to being uncoiled, sectioned if necessary, and adhered to a rigid substrate.

### CROSS-REFERENCE TO RELATED APPLICATIONS

This Application is a Division of application Ser. No. 11/011,634 filed on Dec. 14, 2004.

### FIELD OF THE INVENTION

The present invention relates generally to decorative laminate structures and, more specifically, to a thin laminate sheet constructed of an extruded thermoplastic resin exhibiting certain inventive decorative optical effects, such as in particular translucent monochrome effects with opaque backer, granule effects, metal effects and the like. The laminate sheet is capable of being coiled or rolled to a diameter considerably less than its lesser planar dimension, conveniently packaged and shipped, and adhered at an end location to a rigid substrate.

### DESCRIPTION OF THE PRIOR ART

The prior art is well documented with examples of extruded and decorative articles. The objective in most instances is to provide an attractive surface for use in various structural applications.

A first example of this is set forth in U.S. Pat. No. 6,547,912, issued to Enlow et al., which teaches an extrusion coating process for making a high transparency protective and decorative film. In a first step, a solventless polymeric material is extrusion coated from an extruder die to form an optically clear first layer on a polyester carrier sheet traveling past the extruder die opening. The extrusion coated first layer is cooled and hardened on the carrier sheet, followed by applying a pigmented second layer to the first layer.

The composite paint coat is transferred to a reinforcing backing sheet, after which the carrier sheet is separated from the paint coat to expose the outer surface of the first layer as a high gloss surface with a high distinctness-of-image, providing a transparent protective outer coat for the pigmented second layer. The pigmented second layer can be solvent cast and dried or extruded and hardened as a separate coating on the first layer. The composite paint coat further can be bonded to a coextruded size coat and semi-rigid plastic substrate panel to form a thermoformable laminate.

Additional techniques are disclosed for producing extruded clear films of exceedingly high optical clarity using a closed air flow transport and HEPA filtration system which removes airborne particles from the resin handling and extrusion process, thereby preventing micron-sized contaminants naturally present from any sources from entering the process and degrading ultimate film quality.

U.S. Pat. No. 5,286,528, issued to Reafler, teaches a protective and decorative sheet material for covering a substrate layer and which includes a flexible carrier film, a paint layer adhered to one surface of the carrier film and containing light reflective flakes, and a transparent polymeric top coat overlaying and adhering to the paint layer and having a thickness of at least about 0.1 millimeter. The sheet material exhibits a substantially unstressed relaxed state and a relaxed area and which is heat softenable to a substantially plastic state in which it is extendable to an extended state having an extended area tip to at least 50% greater than the relaxed area.

The paint and topcoat layers exhibit substantially uniform quality and appearance in both the relaxed and extended states. The thick transparent topcoat provides improved retention of gloss and distinctness of image when the sheet material is stretched. A method of preparing the sheet material further includes the step of extruding, in laminar flow, a layer of a cross-linkable transparent topcoat composition over the paint layer.

U.S. Pat. No. 6,206,998, issued to Niazy, teaches a method for making thermoplastic formable sheets laminated with a decorative film, such as one or more layers of glossy clear coat bonded to a layer of pigment containing paint. The method involves providing a thermoplastic formable plastic sheet and applying, on a surface of the plastic sheet, a layer of unsolidified decorative colorant material which forms a decorative first film. Additional steps include curing (if necessary) the decorative material layer to form the adherent first film bonded to the sheet, applying, on the first film, an unsolidified second film for forming a high quality outer surface covering the decorative first film.

Optionally, the decorative sheet may have a first protective layer of thermoformable plastic film removably fixed to the decorative material to protect it from damage during forming of the sheet into a formed part or panel. In auto body trim applications, the formable laminated sheet exhibits a thickness of 0.065″ to 0.30″ and is preferably compression formed with optional thermoforming steps included with, or in place of, compression forming. A second removable protective layer of film may be applied over the first layer to protect against damage prior to compression forming of the sheet.

U.S. Pat. No. 4,810,540, issued to Ellison et al., teaches a flexible decorative sheet material for use in surfacing automobile body panels and the like. The sheet material is characterized by having the appearance of a base coat/clear coat paint finish. The material includes a substantially transparent outer layer, and a pigmented coating on the undersurface of the outer layer which is visible therethrough. The pigmented coating preferably has reflective flakes uniformly distributed therein to import to the sheet material the appearance of a base coat/clear coat paint finish. Also disclosed are shaped articles, which have such sheet materials adhered to one side thereof, and a method for making such sheet materials.

U.S. Pat. No. 6,607,831, issued to Ho et al. teaches a multi-layered article comprising a first layer of a thermoset polyurethane. A second layer of a polymeric composition is bonded to the first layer. The polyurethane has available isocyanate groups prior to the application of the second layer and which is applied onto the first layer in a pre-polymeric or polymeric state wherein the material has carboxyl groups and a cross-linking agent.

Finally, Japanese Patent Publication No. 2003/340948 teaches a lightweight laminated sheet exhibiting high longitudinal and crosswise folding strength. This is obtained by laminating a corrugated fiberboard sheet for combination with the number of corrugation crests of not less than 120 per 30 cm and a corrugation height of not more than 0.6 mm. An attractive decorative printed sheet is applied over the corrugated substrate to complete the assembly

### SUMMARY OF THE INVENTION

The present invention discloses a thin laminate sheet constructed of an extruded thermoplastic-based matrix resin with embedded granules. The laminate sheet is capable of being coiled or rolled to a diameter considerably less than its lesser planar dimension, conveniently packaged, shipped, uncoiled, sectioned and adhered at an end location to a rigid substrate.

The laminate sheet of material of a preferred embodiment exhibits a substantially translucent viewing surface, combined with at least one substantially opaque interior layer such that the translucent layer is not optically clear and it can be viewed into a depth and not just on its surface. In one embodiment, succeeding layers may be exhibit either of a substantially transparent or a partially opaque visibility, and such substantial opacity that the interior defined layers are not visible to an extent of a first interior layer, however may still permit a small or incremental amount of light to pass therethrough. A substantially opaque resin based material may be coextruded to produce a decorative laminate and which possesses a thickness, in a preferred embodiment, of under 0.100″.

A method of producing a laminate sheet includes the steps of combining volumes of the thermoplastic resin, typically as crushed, ground, or otherwise compounded plastic media, typically in the form of pre-compounded pellets (it being noted that the material may be handled in a virgin state and the necessary ingredients added as needed into the matrix), along with a volume of crushed or otherwise sized granule exhibiting a high aspect ratio (substantially flattened with significantly greater two-dimensional properties). Additional volumes of thermoset resin, minerals, fiber and substantially spherical granules may be admixed with the thermoplastic/granulate recipe in order to modulate the decorative, structural, and rheological aspects of the laminate sheet material.

Additionally, a method or producing and distributing a flexible laminate material for remote installation includes producing a substantially thin and decorative veneer laminate sheet having a specified planar length and width, coiling the sheet about its least planar dimension and to a diameter lesser than said planar dimension, packaging and transporting the laminate sheet, and uncoiling and adhering the sheet to a rigid substrate. The adhesive may be applied to a backside of the decorative laminate material shortly after manufacture of the sheet, in which case the adhesive is covered by a peel-away layer shortly prior to fabrication to a substrate. Alternatively, the adhesive may be cured to a non-tacky state and left uncovered on the rear surface of the sheet. The flexural modulus associated with the decorative laminate further permits it to be applied to, and retained in contact with, an uneven surface associated with the substrate.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view illustrating a sheet of a decorative laminate material according to a preferred embodiment of the present invention;

FIG. 2 is a succeeding illustration of the sheet of decorative material coiled to a diameter less than its lesser planar dimension;

FIG. 3 is an enlarged sectional illustration of the plastic laminate material according to a preferred variant and illustrating a first substrate layer and a succeeding topcoat layer exhibiting flat planar granules;

FIG. 4 is a cutaway view taken along line 4-4 of FIG. 3 and further illustrating a substantially transparent top coat layer applied to the laminate material in order to produce a three strata layered material;

FIG. 5 is an exploded partial view of the multi-strata layered material of FIG. 4 and further illustrating the clear cap, semi-transparent (opaque), and fully opaque layers according to the present invention;

FIG. 6 is an illustration in perspective of an installation step according to the present invention and showing the flexible sheet of decorative material adhered to a surface associated with a rigid substrate;

FIG. 7 is a partial side illustration of an arcuate edge configuration application of laminate decorative sheet according to the present invention;

FIG. 8 is a plan view illustration of a pair of sheets of laminate material in a “V” grooved edging application according to the present invention;

FIG. 9 is a schematic representation of a method of producing and applying a thin, coilable plastic laminate material according to the present invention;

FIG. 10 is a partial perspective view of a peel away backing layer associated with a (multi) layer flexible sheet;

FIG. 11 is an example of a ribbon-style sheet produced according to the invention; and

FIG. 12 is a partial perspective of a sheet cured and cut into ribbons using a slitter knife bar.

### DETAILED DESCRIPTION OF THE PREFERRED EMBODIMENTS

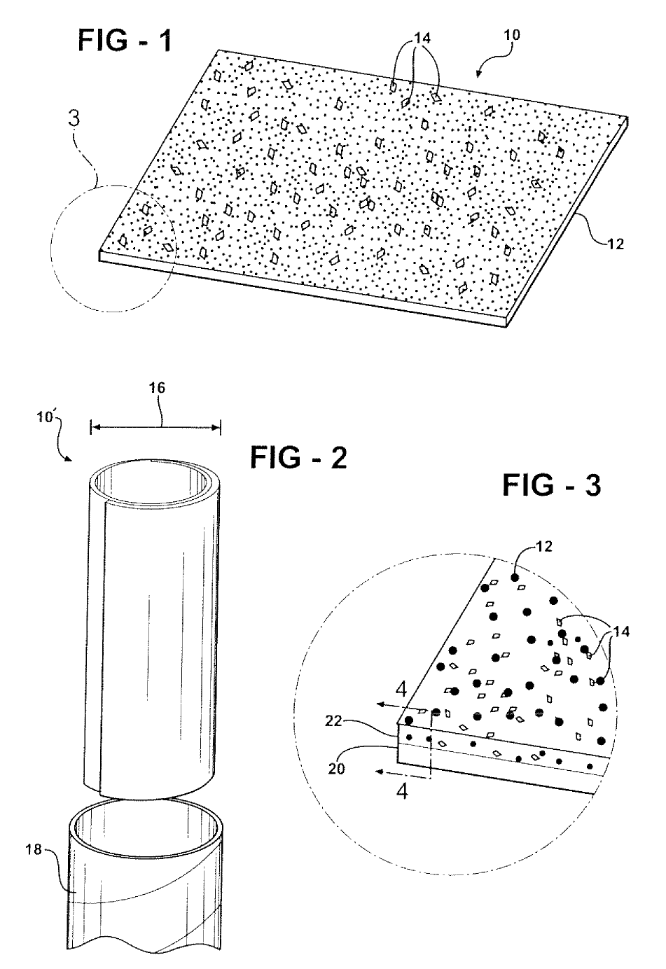

Referring now to FIG. 1, a perspective view is shown at 10 of a sheet of a decorative laminate material according to a preferred embodiment of the present invention. In a preferred embodiment, the decorative veneer laminate is produced in a 4′×8′ sheet, and typically exhibiting a thickness in a range of 1/32″ to ⅛″. Preferably, a thickness range of between 0.010″ up to 0.150″ is employed to produce a laminate sheet exhibiting a desired flex modulus, it being understood further that no specific thickness range is required so long as the laminate sheet material thus created exhibits the necessary properties of coil-ability and breakage/chip resistance.

The laminate sheet is constructed of thermoplastic matrix 12, typically provided in pre-compounded and pellet form, combined with a volume of granules 14. The sheet is extruded, according to known manufacturing processes, to its desired and planar length, width and thickness and such that the sheet exhibits at least a substantially transparent or translucent viewing surface, revealing the granules. The granules 14 may further be intermixed with additional liquid pigments and/or colorization to increase the appeal of the decorative laminate thus produced.

The granules are intended to provide a similar or at least compatible flex modulus as compared to the resinous mixture within which the granules are admixed/entrained. Additionally, a coefficient of thermal expansion (CLTE) associated with the selected granules is, in a preferred embodiment, within sixty (60%) percent of a corresponding CLTE associated with the layer of material, e.g. resin, within which it is entrained.

In varying preferred embodiments, granules exhibit high aspect ratios, typically having much greater two-dimensional length and width, and in comparison to very thin thicknesses such as in a range of 0.001″ to 0.008″. In one application, the granules may include material structure including both natural and synthetic polymers such as mica, silica based materials, and formed crystalline structures

The granules may further include at least one of a mineral and a bio-polymer cellulosic film source. As such, the granule surface may exhibit a metallic finish such as gold, silver, aluminum, brass, iron, and rust. It is also contemplated that at least twenty (20%) percent of the granules, by weight, exhibit a mean planar dimension less than 0.150″.

Correspondingly, the thermoplastic resin base, e.g., typically amounting to roughly at least 50% by volume of the laminate recipe, may also be derived from various cellulosic sources (e.g., vegetable, plant, tree, pulp). In the extrusion process for producing the flat planar sheets, additional minor volumes of co-extruded components, such as minerals, thermoset resin, fibers, and the like may be added to adjust the desired structural and decorative aspects of the laminated sheet

As further illustrated in FIG. 2, and once produced the laminate sheet, referenced here at 10′, exhibits a flex modulus which permits the sheet to be coiled to a diameter 16 less than its least planar dimension. In a preferred embodiment, the thin laminate sheet is capable of being coiled to a diameter of no greater than a factor of 0.4 of its lesser planar dimension. For a 4′×8′ planar sheet, this would amount to a coiled dimension of 1.6′ In another preferred, a coiled diameter of 16″ or less is possible. As will be described in further detail throughout the succeeding embodiments the coiled laminate sheet 10′ is capable of being easily packaged, such as by inserting into a durable (such as corrugated) tube or sleeve 18 for shipment. A further feature of the coiled laminate sheet is that its flexular modulus is such that the incidence of cracking and chipping of the sheet, and in particular its edges, is minimized.

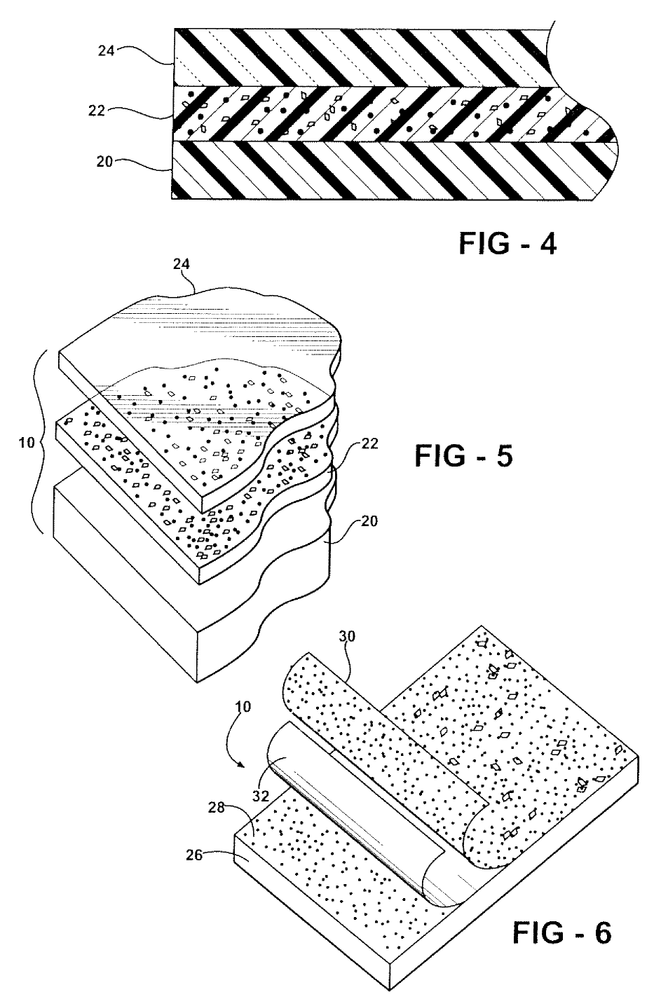

As shown in FIG. 3, an enlarged sectional illustration of the plastic laminate material according to a preferred variant illustrates a first substrate layer 20 and a succeeding topcoat layer 22 exhibiting the flat granules 14. As further referenced in the cutaway view of FIG. 4, a further variant illustrates a substantially transparent top coat 24 applied to the laminate material in order to produce a three strata layered material. Consistent with the earlier description, a resinous base may include at least one layer consisting of at least forty (40%) by weight of a cellulosic material drawn from a group including at least one of vegetable, plant, tree, wood, plant and pulp sources; particularly it any wood pulp has an index of refraction approximately matching the resin of the state it is entrained within.

As further shown in FIG. 5, an exploded partial view of the multi-strata layered material of FIG. 4 illustrates the clear cap 24, semi-transparent (opaque) 22, and fully opaque 20 layers according to the present invention. It is further understood that any reasonable number of coextruded layers can be implemented in the extrusion/coextrusion of the laminate sheet, the preferred embodiments typically exhibiting one, two or three such strata systems.

It is also envisioned that, in a further envisioned embodiment, a flexible laminate sheet material can be produced and which includes a first substantially thin layer exhibiting a length, width and thickness, such a layer including at least 50% by volume a thermosplastic resin. Applied to the first layer, such as in co-extruded or otherwise applied fashion, is a second layer within which is exhibited at least 20% by weight of at least one of a mineral, glass, and thermoset resin.

Without further elaboration, it is also envisioned that nanotechnology ingredients, possibly in combination with temperature-controlled extrusion processes may be applied to create the desired resin based layers and which may contain admixed volumes of solid or flowable decorative material. Other manufacturing considerations contemplate reducing an associated coefficient of expansion/contraction to a degree of 30-50% or less between corresponding raw and finished products. Such an article thus created may further include less than 100% opacity in a main (monolith) layer, as well as a desired change or corresponding matching in a given index of refraction between resinous materials corresponding to filler and median layers.

Referring now to FIG. 6, an illustration is shown in perspective of an installation step according to the present invention and showing a flexible sheet of decorative material, such as previously identified at 10, adhered to a surface associated with a rigid substrate 26. Fabrication and application of the laminate sheet typically occurs at a remote location, such as associated with an installer, and typically includes an adhesive or tacky surface applied either to an exposed application surface 28 of the rigid substrate and/or an underside surface 30 of the laminate sheets and such as which is further covered by a peel-away backing 32.

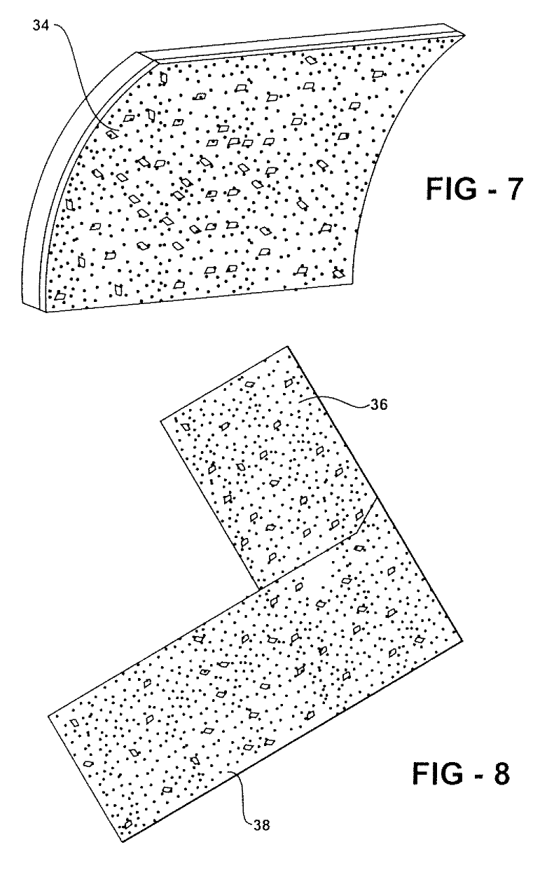

As is further known in the art, the adhesive may be in the form of contact cement or other suitable material which will securely and permanently hold the laminate to the rigid substrate. The rigid substrate may further include any of a wood, polymer or mineral based (gypsum) material. FIG. 7 illustrates a partial side view of an arcuate edge configuration application 34 of a laminate decorative sheet applied to an associated substrate material. FIG. 8 further illustrates a plan view of a pair of fabricated sheets 316 and 318 of laminate material in a “V” grooved edging application according to the present invention. Additional applications of flexible laminate include vacuum forming to a desired rigid substrate or applying a thermal rolled radiused edge system.

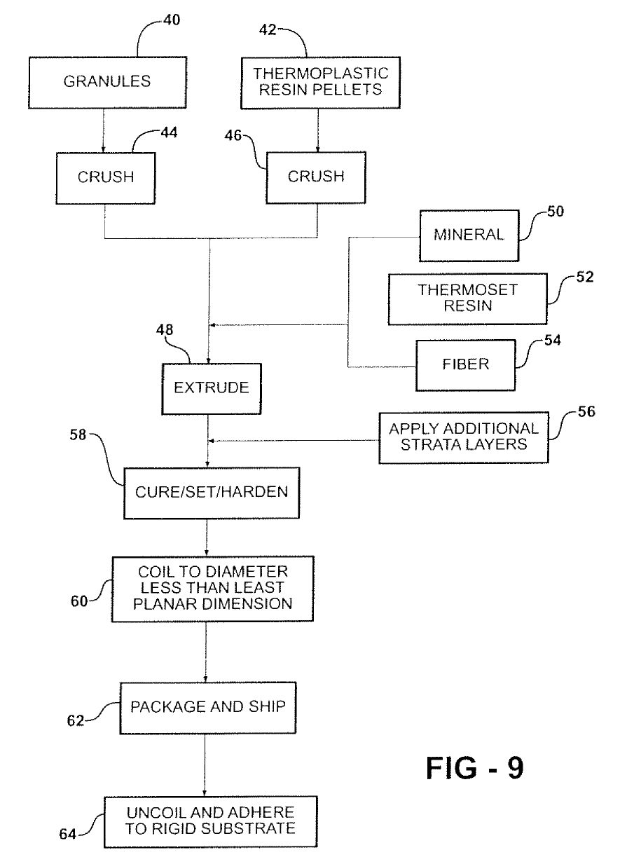

Referring to FIG. 9, a schematic representation is shown of a method of producing and applying a thin, coilable plastic laminate material according to the present invention. In particular, the method includes providing an admixture of granules 40 and thermoplastic resin pellets 42, crushing each, at 44 and 46, and prior to passing the mixture to an extrusion process 48. Optionally, additional volumes of materials including minerals 50, thermoset resin 52 and fiber 54 can be included with the extruded mixture and in order to adjust the decorative and structural aspects of the laminate sheet.

The process steps employed in this particular embodiment include such as 1) creating a desired polymer melt 2) introducing therein a granulate material of desired consistency, 3) extruding into a generally sheet configuration, and/or 4) optionally coextruding at least two layers, at least one of which is substantially opaque. Additional steps include 5) curing the sheet and 6) optionally mechanically abrading, typically in random fashion, the top-most surface of the sheet and optionally slitting the sheet into narrow ribbons suitable for edge band applications.

At step 56, additional strata layers can be coextruded, such as in the form of semi-opaque or substantially transparent layers as previously described. At step 58, the extruded sheet thus produced is cured, set and hardened. At step 60, the laminate sheet is coiled about its lesser planar dimension, packaged and shipped at 62 and, finally, at 64 is uncoiled and adhered to a rigid substrate. A method for producing a flexible laminate material, as well as producing and distributing such a remote material for remote installation, is also disclosed and which embodies steps corresponding to the structure discussed above.

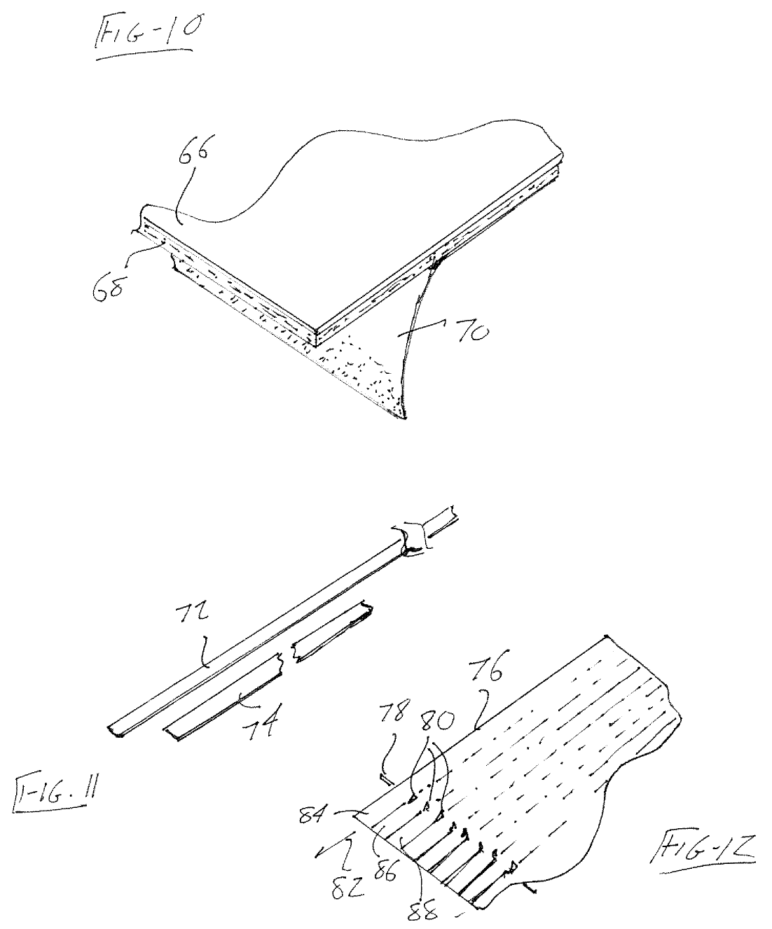

Referring to FIG. 10, a flexible decorative sheet is illustrated and, consistent with the previous embodiments disclosed, includes such as a top (transparent or translucent) layer 66 and a backer (such as partially or substantially opaque) layer 68, it also being understood that a single layer or any multiple number of layers can be incorporated into the decorative and rollup laminate construction. A peel-away sheet or layer 70 is illustrated (such as a thin plastic material with a shiny attaching surface) and which, upon being removed in the fashion illustrated, altos the rear surface of the decorative sheet to be secured to such as a rigid backing (not shown). The rear surface of the sheet can also be surface activated, such as by a suitable chemical reaction or the like, and prior to bonding to the rigid substratum.

Referring, to FIG. 11, a plurality of ribbon shaped strips are illustrated, see examples 72 and 74 in reduced length fashion. In one non-limiting variant, the ribbon shaped strips (such as for example exhibiting at least a 0.5″ width, 96″ length and thickness according to any of the ranges disclosed in the several embodiments) can be pre-formed and (oven) cured in their final shape. Subsequent steps may also include such as mechanically abrading a top surface of the cured sheet and prior to application (such as which may further include application of a peel away backer or surface activated rear face as previously described).

Referring finally to FIG. 12, a partial perspective view is shown of a sheet 76 in an alternate application to that of FIG. 11 and which is pre-formed and cured in the manner described above, following which it is sectioned by a slitter knife bar 78 (this exhibiting a plurality of spaced apart blade edges 80 also commercially understood to include such as multiple overlapping roller blades or other such assemblies known in the commercial art). The sheet is translated in a linear direction, such as shown at 82, over the blade locations 80, the result of which is that a number of individual strips, see at 84, 86, 88, et, seq., are sectioned from the sheet 76.

Another related process application according to the present inventions for making, a decorative thermoplastic-based laminate sheet material, contemplates (pre) coloring at least first and second groups of granulate material, and before they are either entrained, mixed or otherwise combined with the thermoplastic matrix (and such as which may further exist in either a liquid or powdered form) Such coloring may include a homogenous type by admixing colorants into the granule bodies prior to final sizing and most preferably prior to any such sizing. Alternatively, such coloring may take the form of bonding pigments or dyes or a composition of such onto a surface of the granules. Other steps include sizing such that no more than 20%, by weight of a total volume of the granulates to be greater than 0.004″, as well as sizing a further less than 20% by weight to be smaller than 0.5″. Yet additional steps include adding a volume of at least one of a mineral, a thermoset resin, powder, granule, and a fiber to the combined granulates and plastic matrix.

An additional portion of the granulate can be sized to exhibit an aspect ratio of at least 2.0. Additional steps include forming into a sheet a combination of the granulates and plastic matrix, the granulates being dispersed in three dimension within at least one stratum associated with the sheet, and further such that the granulates are suspended within and visually differentiable from the matrix, curing the sheet into a solid form and coiling to a diameter less than 18″, without detrimental affect to its physical properties. In one preferred embodiment, the granules with an aspect ratio greater than two are, by a numerical majority, in contact with the matrix resin they are entrained within on both larger planar sides.

Further process constraints can be managed such that granules below 0.004″ in mean planar diameter substantially do not orient to a parallel alignment with the uppermost surface off the sheet article, and that a numerical majority with an aspect ratio greater than three and larger in mean planar diameter than 0.1 do align in a parallel fashion to at least one surface of the sheet.

Further steps include combining the granulate with the plastic matrix prior to formation and curing of the sheet and evenly distributing the granulates across a surface area associated with said associated stratum. The granulate containing stratum layer can be further dimensioned so as to be at least 0.005 in thickness and can be cured into a solid object having at least 24″ width and a 48″ length planar dimensions. The formed sheet can also be extruded in a thickness range of between 0.010″ to 0.300″.

Other steps include surface activating a rear surface of the sheet in contact with a solid object (such as a rigid substratum as previously described), as well as mechanically abrading a top surface of the cured sheet, particularly if in a non-directional pattern and to a depth of less than 0.05″. This sanding depth contrasts with the prior art of abrasive planning of typical solid surface sheet products of between 0.1″ to 0.2″. Yet additional steps include both applying an at least partially cured and possibly tacky liquid resin to a backside of the formed and cured sheet, as well as separately applying a peel-away layer revealing the liquid resin.

As previously described, the sheet may be formed (such as during coextrusion) to separately include an opaque backer layer, a clear or transparent top layer, or alternatively to include both a transparent layer on top of said translucent layer and at least one opaque layer on the rear surface of said translucent layer. A portion of the granulate may also be orientated, such as within the formed sheet, in order to exhibit a greatest planar dimension larger than 0.10″ parallel to at least one surface of the sheet. In practice the decorative granulate material can also be suspended, such that both of first and second opposite and planar faces of each granule are in contact with the plastic matrix.

An additional variant of the present method further contemplates the steps of producing a substantially thin and decorative veneer laminate sheet having a specified planar length and width, bonding the sheet to a planar substrate material, cutting at least one elongated groove along a rear lacing surface of the substrate and into an adhering surface of the laminate, and without penetrating a laminate outer surface, and filling a groove created thereby with an adhesive and collapsing the groove upon itself to create a finished 90 degree edge. A further process step of heat application along the groove may be used to clear stress-whitening and/or to cure the glue. An additional associated method step contemplates texturing a viewing surface of the laminate sheet with a selected pattern of projections and in order to increase a level of light diffusion of the surface.

It would also be envisioned that one or ordinary skill in the art can further replace the extrusion step in the manufacturing sequence with that of a typical injection molding operation, and it is assumed that these are literal equivalents of each other. Additional non-limiting examples of such processes would include as follows, it being further understood that the several steps or iterations are capable of being employed successively, alternatively, or in combination as dictated by the desires of one of ordinary skill in the art:

1) Providing a polypropylene sheet, such as exhibiting 0.035″ thickness with a translucent top layer of 0.022″ with 10% colored mica granules with an aspect ratio greater than 7; with entrained granules, an opaque backer, of 0.012″ and a cured liquid resin backer of 0.0005″ via a heat oven, the top two layers all formed by co-lamination, and the cured resin by application of a curtain roller;

2) Repeating the above procedure, with the exception of substituting co-lamination of the top 2 layers in favor of a co-extrusion process;

3) Repeating the process of 2), but with the addition of 5% by weight of the translucent layer and removing 3% of the mica granules those being spherical ‘smashed ingot’ granules between 0.002″ and 0.05″ in diameter.

4) Substituting 100% of the mica granulates to additional pigmented granules with silver and sized between 11″ and 0.004″ in order to create high reflectivity;

5) Utilizing a clear granule substrate (e.g., glass, silica, thermoset resin) with an index of refraction to 0.030″ of the resin, into which is entrained a reflective pigment to create mirror chips included in color effect;

6) Utilizing two shades of a similar color to create depth in color;

7) Creating a sheet exhibiting an opaque backer layer at 3.5 times a thickness of an upper layer (such as 0.022″ thick) and in order to create a thermoformable, semi-structural sheet Product.

8) Producing a sheet having a top layer (such as 0.020″ thickness), a bottom layer (such as 0.018″ thickness) the bottom layer being treated with industrially available flame suppressants and the overall product testing to a class A rating (such as according to standard testing parameters known in the relevant industrial art). ASTM E-84

9. Applying a random orbital head sanding operation to a linearly translating (running) sheet, and such that 0.00025″ of surface thickness is removed, the sheet thereby exposing a mineral on its uppermost surface, with improved hardness and wear characteristics;

10. Applying and in-line corona treatment and liquid resin application;

11. Providing a portion of the granulate having a planar size of between 0.3″ and 0.5″ and a thickness of 0.005″, a portion of said granulate volume, such as by weight, being exhibiting a (light) color;

12. Co-extruding or co-laminating all the layers of the sheet such that they exhibit the same color to the naked eye; and

13 Curing the sheet into a solid object having any desired (planar) configuration, such as for example 24″×48″, but also including such steps as curing the sheet into (multiple) ribbons, such as which are each 0.5″ to 1.25″ in width and at least 96″ in length.

Heaving described my invention, other and additional preferred embodiments will become apparent to those skilled in the art to which it pertains, without deviating from the scope of the appended claims.

I claim:

1. A method for producing a flexible laminate material comprising the steps of:
admixing a volume of a thermoplastic resin with a volume of decorative granulate material;
extruding said combined volume of resin and granulate in sheet form, said sheet exhibiting first and second planar dimensions to a thickness less than 0.3 inches;
forming and hardening said sheet such that said granules are interiorly suspended in three dimensional fashion; and
coiling said sheet to a diameter less than its least planar dimension, and without affect to it physical properties upon subsequent uncoiling.

2. The method as described in claim 1, further comprising the step of bonding said sheet to a rigid substrate material.

3. The method as described in claim 1, further comprising the step of evenly distributing, said plurality of granules throughout a defined layer of said sheet.

4. The method as described in claim 1, further comprising the step of providing at least a portion of said granules with an aspect ratio of at least 2.0.

5. The method as described in claim 1, further comprising the step of coiling said sheet to a diameter of no greater than 16″.

6. The method as described in claim 2, further comprising the step of coextruding said sheet with at least one substantially opaque layer.

7. The method as described in claim 1, further comprising the step of suspending said decorative granulate material such that a majority of said granules have both of first and second opposite and planar faces of each granule are in contact with said thermoplastic resin.

8. The method as described in claim 1, further comprising the step of applying at least one substantially clear top coat layer to said extruded sheet.

9. The method as described in claim 1, further comprising the step of screening and pre-mixing, into said fluidic resin, a plurality of granules along with a volume of thermoplastic resin pellets.

10. The method as described in claim 1, further comprising the step of adding a volume of at least one of a mineral, thermoset resin and fiber to said combined thermoplastic resin and granules.

11. The method as described in claim 1 such that said sheet further comprises the steps of coextruding a first substantially transparent layer, a second substantially opaque layer and a third substantially opaque layer.

12. The method as described in claim 1, further comprising the step) of extruding said sheet in a thickness range of between 0.01″ to 0.300″.

13. The method as described in claim 1, further comprising the step of applying an at least partially cured liquid resin to a backside of said sheet.

14. The method as described in claim 13, further comprising the step of applying a peel-away layer revealing said liquid resin.

15. The method as described in claim 13, further comprising the step of injection molding at least one additional layer selected from the group including a thermoplastic, a thermoset, and a glass.

16. A process for making a decorative thermoplastic-based laminate sheet material, comprising the steps of:
coloring at least first and second groups of granulate material;
sizing at least 20%, by weight of a total volume of said granulates greater than 0.004″ and a further at least 20% by weight smaller than 0.5″;
sizing at least a further portion of said dispersed granules such that they exhibit an aspect ration of at least 2.0;
forming into a sheet a combination of said granulates and a plastic matrix, said granulates being dispersed in three dimension within at least one stratum associated with said sheet and such that said granulates are suspended within and visually differentiable from said matrix;
curing said sheet into a solid form; and
coiling said sheet to a diameter less than 18″ and without detrimental affect to its physical properties.

17. The process as described in claim 16, further comprising the step of combining said granulates with said plastic matrix prior to information of said sheet.

18. The process as described in claim 16, further comprising the step of evenly distributing said granulates across a surface area and in three dimension associated with said associated stratum.

19. The process as described in claim 16, further comprising the step of dimensioning said granulate containing stratum layer in a range of between 0.005″ to 0.3″ in thickness.

20. The process as described in claim 16, further comprising the step of curing said sheet into a solid object having at least 24″ width and a 48″ length planar dimensions.

21. The process as described in claim 16, further comprising the step of curing said sheet and dividing into ribbons exhibiting at least 0.5″ in width and at least 96″ in length.

22. The process as described in claim 20, further comprising the step of surface activating a rear surface of said sheet.

23. The process as described in claim 16, further comprising the step of mechanically abrading a top surface of said cured sheet.

24. The process as described in claim 16, further comprising the step of forming said sheet to include a substantially opaque backer layer

25. The process as described in claim 16, further comprising the step of orienting a portion of said granulates having a greatest planar dimension larger than 0.05″ to be parallel to at least one surface of said sheet

26. The process as described in claim 16, further comprising the step of coextruding said sheet with at least one transparent layer and at least one substantially opaque layer.

27. The process as described in claim 16, further comprising the step of suspending said decorative granulate material such that both of first and second opposite and planar faces of each granule are in contact with said plastic matrix.

28. The process as described in claim 17, further comprising the step of adding a volume of at least one of a mineral, a thermoset resin and a fiber to said combined granulates and plastic matrix.

29. The process as described in claim 26, further comprising the step of extruding said sheet in a thickness range of between 0.010″ to 0.300″.

30. The process as described in claim 16, further comprising the step of applying an at least partially cured liquid resin to a backside of said formed and cured sheet.

31. The process as described in claim 30, further comprising the step of applying a peel-away layer revealing said liquid resin.
